(19) United States
(12) Patent Application Publication
(10) Pub. No.: US 2026/0146972 A1
(43) Pub. Date: May 28, 2026

(54) SYSTEM AND METHOD FOR DEFECT DETECTION OF THERMAL BARRIER COATING SYSTEM IN CONFINED SPACE BASED ON FLEXIBLE INTERNAL-EXTERNAL INTEGRATED EXCITATION SENSING

(71) Applicant: XI'AN JIAOTONG UNIVERSITY, Xi'an (CN)

(72) Inventors: Shejuan XIE, Xi'an (CN); Zongfei TONG, Xi'an (CN); Tiejun WANG, Xi'an (CN); Zhenmao CHEN, Xi'an (CN); Chenyu JIA, Xi'an (CN); Wei GUO, Xi'an (CN); Peng JIANG, Xi'an (CN)

(21) Appl. No.: 19/455,121

(22) Filed: Jan. 21, 2026

(30) Foreign Application Priority Data
Jul. 11, 2025 (CN) 202510958930.6

(51) Int. Cl. G01N 27/90

(52) U.S. Cl. CPC G01N 27/9046; G01N 27/9006

(57) ABSTRACT

A system for defect detection of a thermal barrier coating system in a confined space based on flexible internal-external integrated excitation sensing, including a flexible probe and an internal-external integrated excitation sensing device. The flexible probe includes a dual-layer meander-type flexible excitation coil, a flexible electromagnetic detection coil array, a thermal insulation aerogel and a patch-type flexible electronic-ionic temperature sensor array. The thermal insulation aerogel is arranged between the flexible electromagnetic detection coil array and the patch-type flexible electronic-ionic temperature sensor array. The internal-external integrated excitation sensing device includes a temperature acquisition unit, a control-storage unit, a time-series control unit, a high-power current source excitation unit and an electromagnetic signal acquisition unit. The control-storage unit is connected to the temperature acquisition unit, the time-series control unit and the electromagnetic signal acquisition unit. A defect detection method based on such system is also provided.

### CROSS-REFERENCE TO RELATED APPLICATIONS

This application claims the benefit of priority from Chinese Patent Application No. 202510958930.6, filed on Jul. 11, 2025. The content of the aforementioned application, including any intervening amendments thereto, is incorporated herein by reference in its entirety.

### TECHNICAL FIELD

This application relates to electromagnetic non-destructive detection of typical defects in blade thermal barrier coating systems, and more particularly to a system and method for defect detection of a thermal barrier coating system in a confined space based on flexible internal-external integrated excitation sensing.

### BACKGROUND

Thermal barrier coating is typically designed to protect high-temperature structures, and has been widely popularized in the fields of aviation and energy, such as turbine blades of aircraft engines, gas turbines for power generation and combustion chambers of rocket engines. These components are often subject to strong impact force, extremely high temperatures and complex thermal stress fluctuation, and thus are closely associated with the safe operation and service life of an engine. However, various defects will occur under the prolonged exposure to high temperature and physicochemical corrosion, which will further result in the coating spallation, leading to serious economic losses and safety risks. Therefore, the nondestructive detection of substrate crack and interface debonding defects in a thermal barrier coating system is crucial for evaluating reliability and service life of related products during manufacturing and operation, as well as for providing maintenance strategies.

Currently, the substrate crack and interface debonding defects of the thermal barrier coating systems are generally monitored by eddy current testing, ultrasonic testing, infrared thermography or terahertz detection. Nevertheless, these technologies are only applicable to the detection of a single defect, and the quantitative identification technology of multiple defects is still absent in the prior art. The eddy current testing relies on a rigid probe for manual scanning, and can only identify a single defect (substrate crack) with a relatively small detection area. An excitation unit of the traditional eddy current thermography is made of water-cooled copper tubes, which struggles with a thick diameter, a large volume and a rigid shape, making it impossible to achieve electromagnetic excitation for complex curved structures in a confined space. Moreover, an infrared camera requires a sufficient field of view to capture a temperature field signal, and thus fails to achieve the collection of temperature signals within a confined space.

### SUMMARY

In order to achieve quantitative identification and classification of two typical defects of substrate crack and interface debonding in thermal barrier coating systems of the blades with complex configurations in a confined space, the present disclosure provides a system and method for defect detection of a thermal barrier coating system in a confined space based on flexible internal-external integrated excitation sensing. The system and method provided herein can be applied to the confined space and adapted to a complex curved structure, and have advantages of high heating efficiency, high response speed and integrated detection of multiple defects. As a consequence, the system and method provided herein can be extensively applied to the nondestructive quantitative identification and classification of multiple types of complex defects in thermal barrier coating systems of blades within a confined space.

To achieve the above objectives, the present disclosure adopts the following technical solutions.

A system for defect detection of a thermal barrier coating system in a confined space based on flexible internal-external integrated excitation sensing, comprising: a flexible probe applicable to detection of a curved structure of a blade in the confined space; and
an internal-external integrated excitation sensing device;
wherein the flexible probe comprises a dual-layer meander-type flexible excitation coil, a flexible electromagnetic detection coil array, a thermal insulation aerogel and a patch-type flexible electronic-ionic temperature sensor array;
the flexible electromagnetic detection coil array is arranged on the dual-layer meander-type flexible excitation coil;
the thermal insulation aerogel is arranged between the flexible electromagnetic detection coil array and the patch-type flexible electronic-ionic temperature sensor array to eliminate influences of heat generation from internal and external heat sources;
the internal-external integrated excitation sensing device comprises a temperature acquisition unit, a control-storage unit, a time-series control unit, a current source excitation unit and an electromagnetic signal acquisition unit;
the control-storage unit is connected to the temperature acquisition unit, the time-series control unit and the electromagnetic signal acquisition unit to control a release of an excitation and an acquisition of test information, such that the release of the excitation and the acquisition of test information are synchronously performed;
the time-series control unit is connected to the current source excitation unit to control the current source excitation unit to output excitation currents with different phases;
the dual-layer meander-type flexible excitation coil, the flexible electromagnetic detection coil array and the thermal insulation aerogel are integrated on a circuit to be connected to the current source excitation unit and the electromagnetic signal acquisition unit sequentially, so as to enable an excitation and acquisition of an electromagnetic field signal;
the patch-type flexible electronic-ionic temperature sensor array is connected to the temperature acquisition unit to output a temperature field signal;
the internal-external integrated excitation sensing device is configured to set excitation current amplitude, frequency, phase and excitation time via the control-storage unit, and to generate a trigger signal;
the control-storage unit is configured to synchronously trigger the temperature acquisition unit, the time-series control unit and the electromagnetic signal acquisition unit, such that the release of the excitation and the acquisition of test information are synchronously performed;
the time-series control unit is configured to receive the trigger signal to control the current source excitation unit to release an excitation, and output the excitation currents with different phases into the dual-layer meander-type flexible excitation coil of the flexible probe;
the dual-layer meander-type flexible excitation coil is configured to generate an alternating magnetic field that is a primary magnetic field in a free space under current excitation to induce an eddy current within a metal substrate of the blade, and according to Joule's law, the eddy current within the metal substrate of the blade is configured to generate an internal Joule heat source; and the dual-layer meander-type flexible excitation coil has an inherent resistance, and the excitation current is configured to pass through the dual-layer meander-type flexible excitation coil to produce an external Joule heat source; and
the dual-layer meander-type flexible excitation coil is configured to closely attach to a surface of the thermal barrier coating system of the blade, such that the external Joule heat source in the dual-layer meander-type flexible excitation coil is configured to be transferred into a thermal barrier coating system of the blade by heat conduction to collaboratively form a thermal excitation with the internal Joule heat source.

In some embodiments, the internal-external integrated excitation sensing not only extremely improves a heating efficiency during a heating stage, but also strengthens a temperature contrast ratio of a defect area to a non-defect area in the thermal barrier coating system of the blade, so that it is more conducive to a non-destructive defect detection by utilizing the temperature field signal during a cooling stage.

In some embodiments, the thermal barrier coating system of the blade comprises two typical defects of substrate crack and interface debonding, wherein the interface debonding only affects the temperature field signal; and the substrate crack affects both the temperature field signal and the electromagnetic field signal, such that a fusion of the electromagnetic field signal and the temperature field signal is configured to enable the classification and quantification of two typical defects of substrate crack and interface debonding in the thermal barrier coating system of the blade.

In some embodiments, the dual-layer meander-type flexible excitation coil comprises an upper coil layer and a lower coil layer; a current path of the upper coil layer is perpendicular to a current path of the lower coil layer; each of the upper coil layer and the lower coil layer is wound in a periodically-symmetric meandering pattern with evenly spaced turns; and in response to a case that the currents with different phases are respectively input to the upper coil layer and the lower coil layer for excitation, the upper coil layer and the lower coil layer are configured to induce a multi-directional eddy current within the metal substrate of the blade, so as to effectively avoid a missed detection caused by a parallelism of the eddy current direction to the crack length.

In some embodiments, an evenly-wound design of the dual-layer meander-type flexible excitation coil is configured to induce a relatively even eddy current field, thereby obtaining a relatively even temperature field, such that it can strengthen a temperature contrast ratio of a defect area to a non-defect area in the temperature signal field to facilitate the quantification of the defects; and a flexible structure of the dual-layer meander-type flexible excitation coil enables it to closely attach to the surface of the thermal barrier coating system of the blade, so as to be sufficiently adapted to the complex curved surface structure of the blade, maximize the heating efficiency of internal Joule heat source and external Joule heat source, and improve detection efficiency and precision.

In some embodiments, the flexible electromagnetic detection coil array comprises a plurality of coils arranged with an array configuration; each of the plurality of coils is configured to independently perform induction, and have a strong response capability to the electromagnetic field signal; a data processing is performed on an output signal of each of the plurality of coils to effectively enhance a strength of a desired signal and decrease an influence of a noise signal, thereby improving a signal-to-noise ratio; spacing and layout of each of the plurality of coils are configured to be adjusted to enable synchronous signal acquisition in a large area, such that a detection sensitivity resolution for minor defects in the thermal barrier coating system of the blade are improved, simultaneously enlarging a test area; and each of the plurality of coils is mutually interacted with each other to effectively decrease the noise signal and improve the signal-to-noise ratio, thereby improving the detection precision of the defects.

In some embodiments, the patch-type flexible electronic-ionic temperature sensor array is configured to be fully flexibility to fit the curved structure of the blade, so as to acquire a complete temperature field signal of a contact area; the patch-type flexible electronic-ionic temperature sensor array has a high sensitivity of 1 mV/K and a dynamic response of 10 ms; and

the patch-type flexible electronic-ionic temperature sensor array comprises a plurality of patch-type flexible electronic-ionic temperature sensors arranged in an array configuration; each of the plurality of patch-type flexible electronic-ionic temperature sensors comprises an ionic conductor temperature-sensing terminal and an electronic conductor sensing terminal; and the ionic conductor temperature-sensing terminal is made of a transparent and stretchable material.

In some embodiments, the material of the ionic conductor temperature-sensing terminal is selected from the group consisting of an ionic gel, a hydrogel, and an ionoelastomer, which have physical properties of transparency, stretchability, high stability and conductivity.

In some embodiments, an array multi-point temperature sensing is configured to enable a temperature distribution detection with a wide range, and improve a spatial resolution of the temperature field signal; compared to an infrared camera, the patch-type flexible electronic-ionic temperature sensor array can test a temperature of the complex curved surface in the confined space when camera vision is limited; compared to a thermocouple, the patch-type flexible electronic-ionic temperature sensor array can achieve a flexible and atomic attachment without manual operation, thereby enabling to simply and quickly operate; moreover, the patch-type flexible electronic-ionic temperature sensor array has the dynamic response of 10 ms to quickly capture a temperature change of a surface of a blade during an initial cooling stage; and it will not scratch a surface material of the blade, so as to protect an integrity of the surface material of the blade.

In some embodiments, heat conduction of the internal Joule heat source generated by the eddy current within the metal substrate of the blade satisfies formula (1):

$$ρ {C}_{p} \frac{\partial T}{\partial t} - ∇ \cdot ( k \cdot ∇ T ) = Q \qquad ( 1 )$$

wherein ρ represents density; Cₚ represents specific heat capacity; k represents thermal conductivity; T represents temperature;

$$\frac{\partial T}{\partial t}$$

represents an instantaneous rate of change of the temperature T with respect to time t; and Q represents an internal Joule heat source.

In some embodiments, a detection method based on the aforementioned system, which can achieve the classification and quantification of two typical defects of substrate crack and interface debonding in a thermal barrier coating system of the blades with complex configurations in a confined space, comprising:
step (1) placing the flexible probe on a surface of the blade; wherein the dual-layer meander-type flexible excitation coil, the flexible electromagnetic detection coil array, the thermal insulation aerogel and the patch-type flexible electronic-ionic temperature sensor array are arranged in sequence from bottom to top to form a multi-layer structure, and the thermal insulation aerogel is configured to enable a thermal insulation between the patch-type flexible electronic-ionic temperature sensor array, and the dual-layer meander-type flexible excitation coil and the flexible electromagnetic detection coil array, and to prevent the patch-type flexible electronic-ionic temperature sensor array from being influenced by internal and external heat sources during an excitation process; and adjusting the flexible probe based on an actual configuration of the blade to fit the surface of the blade;
step (2) before applying the excitation, setting, by the control-storage unit, the amplitude, frequency, phase and excitation time of the excitation current to ensure that the currents with different phases are respectively input into two coil layers of the dual-layer meander-type flexible excitation coil, so as to generate induction eddy currents with different directions;
step (3) during excitation, simultaneously sending, by the control-storage unit, a signal to the temperature acquisition unit, the time-series control unit and the electromagnetic signal acquisition unit to ensure synchronized excitation and acquisition; simultaneously triggering, by the time-series control unit, the current source excitation unit to generate excitations with different phases; picking, by the flexible electromagnetic detection coil array, an electromagnetic signal of substrate crack; and capturing, by the patch-type flexible electronic-ionic temperature sensor array, a temperature signal of both substrate crack and interface debonding;
step (4) at an moment when the excitation is ended, removing the dual-layer meander-type flexible excitation coil, the flexible electromagnetic detection coil array and the thermal insulation aerogel to enable the patch-type flexible electronic-ionic temperature sensor array to fall onto the surface of the blade; and detecting, by the patch-type flexible electronic-ionic temperature sensor array, a temperature signal on the surface of the blade at a cooling stage;
step (5) fusing the temperature signal acquired at the cooling stage with the electromagnetic signal acquired during the excitation process in decision-level; and performing classification and quantification of substrate crack and interface debonding in the thermal barrier coating system based on the decision-level fusion;
wherein in the presence of the substrate crack in the thermal barrier coating system of the blade, a distribution of an eddy current field within the metal substrate will be disturbed, thereby affecting a secondary magnetic field; the flexible electromagnetic detection coil array is configured to pick the change of the secondary magnetic field, so as to identify and quantify the substrate crack based on the electromagnetic signal during the excitation process; and both the substrate crack and the interface debonding will affect thermal conduction process in the thermal barrier coating system, thereby causing a change in temperature distribution on the surface of the blade; and the interface debonding is finally quantified based on disturbed temperature distribution and quantification result of substrate crack from the electromagnetic signal.

Compared to the prior art, the present disclosure has the following beneficial effects.
(1) The present disclosure provides the flexible probe and the internal-external integrated excitation sensing device for defect detection of the blade thermal barrier coating system in the narrow space to overcome a difficulty that an in-situ detection of blades is restricted by space. Compared to the disadvantages of large volume and rigidity of excitation sensing devices in traditional detection system, the system provided herein has a relatively small volume and a full flexibility to enable a perfect attachment between the flexible probe and the complex curved surface of the blade in the confined space. Compared to the acquisition device of traditional infrared camera, the system provided herein acquires the surface temperature of the blade in a confined space with limited field of vision, avoiding detection blind spots.
(2) Compared to traditional non-flexible test probe, the flexible probe adopted herein solves the problems of small contact area, high heat transfer loss and difficulties in signal acquisition when detecting the thermal barrier coating system of the blades with complex configurations in the narrow space. The dual-layer meander-type flexible excitation coil can closely attach to the complex curved surface of the blade to increase the contact area between the excitation coil and the surface of blade, thereby improving the heating efficiency. The flexible electromagnetic detection coil array and the flexible temperature test device can closely attach to the blades to eliminate detection blind spots and improve detection precision.
(3) The present disclosure adopts the dual-layer meander-type flexible excitation coil to effectively eliminate missed detection associated with cracks oriented parallel to the eddy current, and exhibit the advantage to detect the substrate crack in any direction. The dual-layer meander-type flexible excitation coil is input with the currents with different phases to induce the eddy currents with different directions within the metal substrate of the blade, such that it eliminates the missed detection associated with cracks oriented parallel to the eddy current, thereby improving a detection capability for the substrate crack in different directions. Moreover, a linear segment configuration of the meander-type coil can generate a relatively uniform eddy current field within the metal substrate of the blade, so as to generate internal and external heat sources with relatively uniform distribution. These heat sources generate a uniform temperature field in the inspected material, which significantly enhances the temperature contrast between defective and non-defective areas, thereby improving the defect detection capability.
(4) The present disclosure adopts the flexible electromagnetic detection coil array, which can effectively acquire a tiny change of the electromagnetic signal to improve the sensitivity and resolution ratio of crack detection. The flexible electromagnetic detection coil array comprises the plurality of coils. Each of the plurality of coils can independently induce, so as to exhibit strong response capability to the electromagnetic field signal. The array configuration of the coils enables the synchronous signal acquisition in a large area, such that the detection sensitivity and the resolution ratio of tiny defects in the thermal barrier coating system of the blade are improved, simultaneously enlarging a test area. Each of the plurality of coils is mutually interacted with each other to effectively decrease the noise signal and improve the signal-to-noise ratio, thereby improving the detection precision of the defects.
(5) The patch-type flexible electronic-ionic temperature sensor array provided herein has a physical property of full flexibility to enable it to closely attach to the complex curved structure of the blade, so as to acquire a complete temperature field signal of a contact area. Compared to an infrared camera, the patch-type flexible electronic-ionic temperature sensor array can test the temperature of the complex curved surface in the confined space when camera vision is limited. Compared to a thermocouple, the patch-type flexible electronic-ionic temperature sensor array can achieve the flexible and atomic attachment without manual operation, thereby enabling to simply and quickly operate. Moreover, the patch-type flexible electronic-ionic temperature sensor array has the dynamic response of 10 ms to quickly capture the temperature change of the surface of the blade during an initial cooling stage, and it will not scratch a surface material of the blade, so as to protect an integrity of the surface material of the blade.
(6) The present disclosure provides a nondestructive detection method based on internal-external integrated excitation sensing of electromagnetic field and thermal field. The nondestructive detection method ingeniously integrates the internal Joule heat source generated by the induced eddy current field within the metal substrate of the blade and the external Joule heat source produced by the resistive thermal effect of the excitation coil. Compared to single thermal excitation methods, the internal-external synergistic excitation significantly enhances the heating efficiency, thereby improving the detection efficiency and the sensitivity. During the cooling stage, the internal-external thermal synergistic excitation significantly increases the temperature contrast between defective and non-defective areas, facilitating the nondestructive quantification of the defects.
(7) The present disclosure provides the system and method for the defect detection of the thermal barrier coating system in the confined space based on flexible internal-external integrated excitation sensing to achieve the classification and quantification of composite defect in the blade thermal barrier coating system. The typical defects comprise the substrate crack and the interface debonding in the thermal barrier coating system. The substrate crack can disturb the distribution of the eddy current field in the metal substrate of the blade, thereby affecting the signal of the secondary magnetic field. The flexible electromagnetic detection coil array can acquire the change of the secondary magnetic field to achieve the identification of the substrate crack by utilizing the electromagnetic field signal during excitation process. Moreover, both the substrate crack and interface debonding would affect the thermal conduction to cause the temperature distribution of the surface of the blade to change during the thermal conduction based on internal-external integrated excitation. As a consequence, patch-type flexible electronic-ionic temperature sensor array collects the temperature field signal, which comprises the information of the substrate crack and interface debonding. The identification of the substrate crack is achieved through the electromagnetic field signal, and the quantification of the interface debonding is achieved through the temperature field signal, such that the classification and quantification of two typical defects of substrate crack and interface debonding is finally achieved.

### BRIEF DESCRIPTION OF THE DRAWINGS

FIG. 1 schematically shows a flexible probe according to an embodiment of the present disclosure;

FIG. 2 schematically shows a system for defect detection of a thermal barrier coating system in a confined space based on flexible internal-external integrated excitation sensing and an effect verification thereof according to an embodiment of the present disclosure;

FIG. 3 schematically shows a change of an electromagnetic field signal of a flexible electromagnetic detection coil array according to an embodiment of the present disclosure;

FIG. 4 schematically shows a temperature detection effect of a patch-type flexible electronic-ionic temperature sensor array according to an embodiment of the present disclosure; and

FIG. 5 schematically shows a decision-level fusion method for fusing an electromagnetic field signal with a temperature field signal according to an embodiment of the present disclosure.

### DETAILED DESCRIPTION OF EMBODIMENTS

The present disclosure will be further described below with the accompanying figures and the embodiments. The disclosed embodiments are merely illustrative of the disclosure to provide further elaboration on the present disclosure. Unless otherwise specified, the terms are merely for the purpose of facilitating the description of the embodiments, and are not intended to limit the implement methods of the present disclosure.

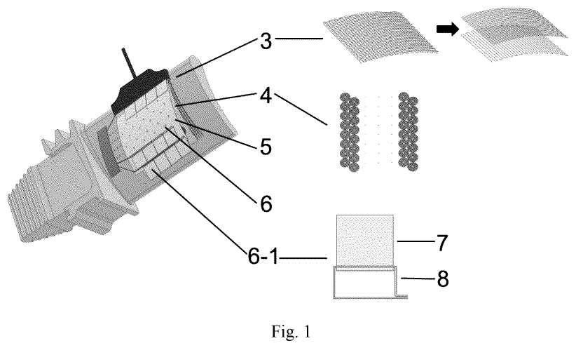

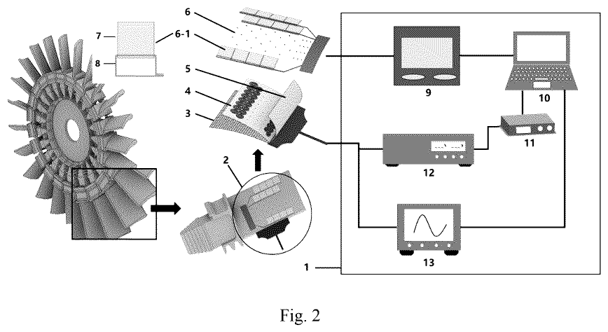

Referring to FIGS. 1-2, the present disclosure provides a system for defect detection of a thermal barrier coating system in a confined space based on flexible internal-external integrated excitation sensing. The system provided herein includes a flexible probe 2 and an internal-external integrated excitation sensing device 1. The flexible probe 2 includes a dual-layer meander-type flexible excitation coil 3, a flexible electromagnetic detection coil array 4, a thermal insulation aerogel 5 and a patch-type flexible electronic-ionic temperature sensor array 6. The flexible electromagnetic detection coil array 4 is arranged on the dual-layer meander-type flexible excitation coil 3. The thermal insulation aerogel 5 is arranged between the flexible electromagnetic detection coil array 4 and the patch-type flexible electronic-ionic temperature sensor array 6 to eliminate influences of heat generation from internal-external heat sources. The patch-type flexible electronic-ionic temperature sensor array 6 includes a plurality of patch-type flexible electronic-ionic temperature sensors 6-1 arranged in an array configuration. Each of the plurality of patch-type flexible electronic-ionic temperature sensors 6-1 includes an ionic conductor temperature-sensing terminal 7 and an electronic conductor sensing terminal 8.

Referring to FIG. 2, the internal-external integrated excitation sensing device 1 includes a temperature acquisition unit 9, a control-storage unit 10, a time-series control unit 11, a current source excitation unit 12 and an electromagnetic signal acquisition unit 13. The control-storage unit 10 is connected to the temperature acquisition unit 9, the time-series control unit 11 and the electromagnetic signal acquisition unit 13 to control a release of an excitation and an acquisition of test information, such that the release of the excitation and the acquisition of test information are synchronously performed. The time-series control unit 11 is connected to the current source excitation unit 12 to enable the current source excitation unit 12 to output currents with different phases. The dual-layer meander-type flexible excitation coil 3, the flexible electromagnetic detection coil array 4 and the thermal insulation aerogel 5 are integrated on a circuit to be connected to the current excitation unit 12 and the electromagnetic signal acquisition unit 13, so as to perform the excitation and acquisition of the electromagnetic field signal. The patch-type flexible electronic-ionic temperature sensor array 6 is connected to the temperature acquisition unit 9 to output a temperature field signal.

A system for defect detection of a thermal barrier coating system in a confined space based on flexible internal-external integrated excitation sensing and an effect verification thereof according to an embodiment of the present disclosure are schematically shown in FIG. 2.

Referring to FIG. 1, nondestructive classification and quantification of two typical defects of substrate crack and interface debonding in a thermal barrier coating system of the blades with complex configurations in a confined space are performed through the following steps.

### (S1) Construction of Detection System

The flexible probe is placed on a surface of a blade. The flexible probe is adjusted based on an actual configuration of the blade to fit the surface of the blade. Amplitude, frequency, phase and excitation time of an excitation current of the current source excitation unit 12 are set to operate the detecting system under optimal parameters.

### (S2) Classification and Quantification of Two Typical Defects of Substrate Crack and Interface Debonding in the Thermal Barrier Coating System of the Blade

When using the flexible probe 2 to detect, currents with different phases are applied to the dual-layer meander-type flexible excitation coil 3 for the excitation. According to the principle of electromagnetic induction, an alternating magnetic field that is a primary magnetic field can be generated in a free space, so as to induce an eddy current with a metal substrate of a blade, thereby generating a secondary magnetic field. The substrate crack can disturb the electromagnetic field signal, such that a change of the secondary magnetic field can be acquired through the flexible electromagnetic detection coil array 4 to achieve the identification of the substrate crack by utilizing the electromagnetic field signal during excitation process. According to Joule's law, on the one hand, the induction eddy current within the metal substrate of the blade can generate an internal Joule heat source. On the other hand, the dual-layer meander-type flexible excitation coil 3 can produce an external Joule heat source due to an inherent resistance effect. As a consequence, the external Joule heat source can synergistically form a thermal excitation with the internal Joule heat source. The thermal conduction process is affected by both the substrate crack and interface debonding thereby inducing a change in the temperature distribution on the surface of the blade. A temperature field signal of the blade is detected via the patch-type flexible electronic-ionic temperature sensor array 6, and is acquired via the temperature acquisition unit 9 during the cooling process. The temperature field signal is fused with the electromagnetic field signal in decision-level to achieve the classification and quantification of the substrate crack and interface debonding.

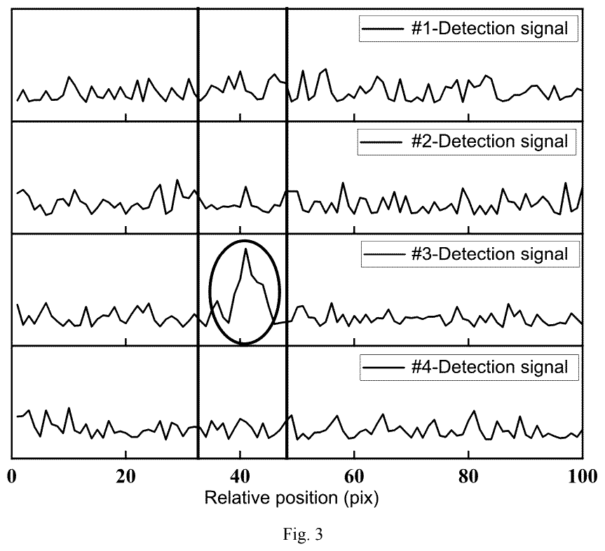

The electromagnetic field signal of each of a plurality of coils in the flexible electromagnetic detection coil array 4 according to an embodiment of the present disclosure is schematically shown in FIG. 3. Each of the plurality of coils in the flexible electromagnetic detection coil array 4 is configured to independently perform induction to acquire an electromagnetic field signal. The acquired electromagnetic field signal is performed with the data processing to observe a signal peak and conclude a relative position of the defect. As shown in a position indicated by a circle in FIG. 3, the classification and quantification of the substrate crack are achieved.

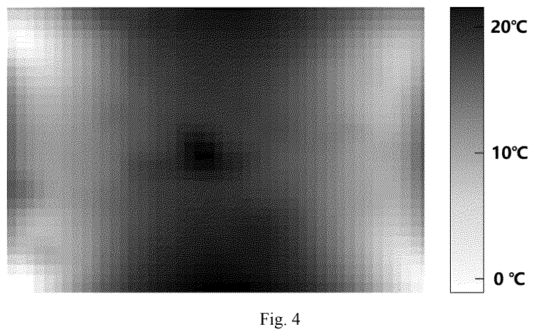

As shown in FIG. 4, it is the detection result of the patch-type flexible electronic-ionic temperature sensor array 6. Each of the plurality of patch-type flexible electronic-ionic temperature sensors 6-1 includes three layers: an electrolyte, a dielectric and an electrode from the perspective of sensing mechanism. During operation, electrons accumulate at an electrode-dielectric interface, and ions accumulate at an electrolyte-dielectric interface to form an ion cloud. Due to the charge imbalance between the ionic charges at the interfaces and the electronic charges, an electric field is established in the electrolyte. Changes in the temperature at the inspected point affect a thickness of the ion cloud. As temperature increases, the ion cloud expands. As temperature decreases, the ion cloud contracts. The variation in ion cloud thickness alters the electric field within the electrolyte, consequently leading to a change in an open-circuit voltage of the electrode, satisfying the formula (2):

$${V}_{e} = \frac{{σ}_{i} + {σ}_{e}}{{ε}_{e}} L - \frac{{σ}_{e}}{{ε}_{d}} d \qquad ( 2 )$$

where Vₑ represents an open-circuit voltage of the electrode; σᵢ represents an areal density of accumulated ionic charges at the electrolyte-dielectric interface; σₑ represents an areal density of accumulated electronic charges at the electrode-dielectric interface; ε_{d} a represents a dielectric constant of the dielectric layer; εₑ represents a dielectric constant of the electrolyte; L represents a Debye length; and d represents a thickness of the dielectric layer.

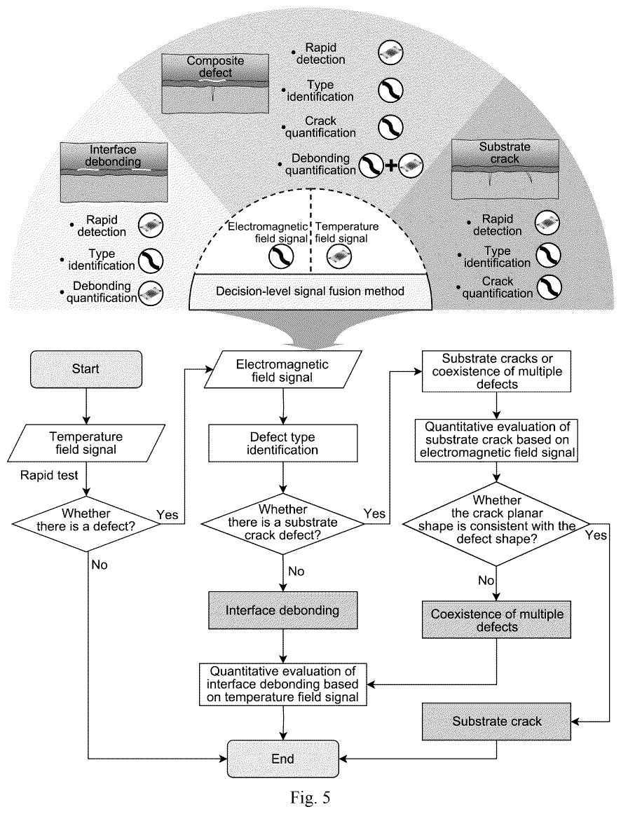

Based on this principle, the surface temperature changes of the thermal barrier coating system of the blade are detected, thereby enabling the decision-level fusion of the electromagnetic field signal detected by the flexible electromagnetic detection coil array 4 with the temperature field signal. According to a decision-level fusion method in FIG. 5, the classification and quantification of the substrate crack and interface debonding in the thermal barrier coating system of the blade is achieved.

The present disclosure provides the electromagnetic detection technology based on internal-external integrated excitation sensing, which is a novel nondestructive detection method. The technology provided herein exhibits high heating efficiency, superior detection sensitivity, capability to identify various defect types, and strong anti-interference performance. It operates by applying an alternating current to an excitation coil to generate a primary magnetic field, which can generate the induction eddy current in the metal material, such that the induction eddy current generates the secondary magnetic field. The flexible electromagnetic detection coil array 4 can acquire the electromagnetic field signal of the secondary magnetic field to enable the nondestructive classification and quantification of the substrate crack. Moreover, the induction eddy current can generate the internal Joule heat source in the metal substrate of the blade, and the external Joule heat source of the coils can be introduced into the blade, such that the external Joule heat source can synergistically form the thermal excitation with the internal Joule heat source. During the thermal conduction process, both the substrate crack and interface debonding can disturb the thermal conduction, such that the patch-type flexible electronic-ionic temperature sensor array can acquire the temperature field signal of the blade surface. Finally, the electromagnetic field signal is fused with the temperature field signal to achieve the classification and quantification of two typical defects of substrate crack and interface debonding in the thermal barrier coating system.

What is claimed is:

1. A system for defect detection of a thermal barrier coating system in a confined space based on flexible internal-external integrated excitation sensing, comprising:
a flexible probe applicable to detection of a curved structure of a blade in the confined space; and
an internal-external integrated excitation sensing device;
wherein the flexible probe comprises a dual-layer meander-type flexible excitation coil, a flexible electromagnetic detection coil array, a thermal insulation aerogel and a patch-type flexible electronic-ionic temperature sensor array;
the flexible electromagnetic detection coil array is arranged on the dual-layer meander-type flexible excitation coil;
the thermal insulation aerogel is arranged between the flexible electromagnetic detection coil array and the patch-type flexible electronic-ionic temperature sensor array to eliminate influences of heat generation from internal and external heat sources;
the internal-external integrated excitation sensing device comprises a temperature acquisition unit, a control-storage unit, a time-series control unit, a current source excitation unit and an electromagnetic signal acquisition unit;
the control-storage unit is connected to the temperature acquisition unit, the time-series control unit and the electromagnetic signal acquisition unit;
the time-series control unit is connected to the current source excitation unit to control the current source excitation unit to output excitation currents with different phases;
the dual-layer meander-type flexible excitation coil, the flexible electromagnetic detection coil array and the thermal insulation aerogel are integrated on a circuit to be connected to the current source excitation unit and the electromagnetic signal acquisition unit;
the patch-type flexible electronic-ionic temperature sensor array is connected to the temperature acquisition unit;
the internal-external integrated excitation sensing device is configured to set excitation current amplitude, frequency, phase and excitation time via the control-storage unit, and to generate a trigger signal;
the control-storage unit is configured to synchronously trigger the temperature acquisition unit, the time-series control unit and the electromagnetic signal acquisition unit;
the time-series control unit is configured to receive the trigger signal to control the current source excitation unit to release an excitation, and output the excitation currents with different phases into the dual-layer meander-type flexible excitation coil of the flexible probe;
the dual-layer meander-type flexible excitation coil is configured to generate an alternating magnetic field in a free space under current excitation to induce an eddy current within a metal substrate of the blade, and the eddy current within the metal substrate of the blade is configured to generate an internal Joule heat source; and the dual-layer meander-type flexible excitation coil has an inherent resistance, and the excitation current is configured to pass through the dual-layer meander-type flexible excitation coil to produce an external Joule heat source; and
the external Joule heat source in the dual-layer meander-type flexible excitation coil is configured to be transferred into a thermal barrier coating system of the blade by heat conduction to collaboratively form a thermal excitation with the internal Joule heat source.

2. The system of claim 1, wherein the dual-layer meander-type flexible excitation coil comprises an upper coil layer and a lower coil layer; a current path of the upper coil layer is perpendicular to a current path of the lower coil layer; each of the upper coil layer and the lower coil layer is wound in a periodically-symmetric meandering pattern with evenly spaced turns; and in response to a case that the currents with different phases are respectively input to the upper coil layer and the lower coil layer for excitation, the upper coil layer and the lower coil layer are configured to induce a multi-directional eddy current within the metal substrate of the blade.

3. The system of claim 1, wherein the flexible electromagnetic detection coil array comprises a plurality of coils arranged in an array configuration; each of the plurality of coils is configured to independently perform induction; and spacing and layout of the plurality of coils are configured to be adjusted to enable synchronous signal acquisition.

4. The system of claim 1, wherein the patch-type flexible electronic-ionic temperature sensor array is configured to be fully flexibility to fit the curved structure of the blade, so as to acquire a complete temperature signal of a contact area; the patch-type flexible electronic-ionic temperature sensor array has a sensitivity of 1 mV/K and a dynamic response of 10 ms; and
the patch-type flexible electronic-ionic temperature sensor array comprises a plurality of patch-type flexible electronic-ionic temperature sensors arranged in an array configuration; each of the plurality of patch-type flexible electronic-ionic temperature sensors comprises an ionic conductor temperature-sensing terminal and an electronic conductor sensing terminal; and the ionic conductor temperature-sensing terminal is made of a transparent and stretchable material.

5. The system of claim 4, wherein the ionic conductor temperature-sensing terminal is made of an ionic gel, a hydrogel or an ionoelastomer.

6. The system of claim 1, wherein heat conduction of the internal Joule heat source generated by the eddy current within the metal substrate of the blade satisfies formula (1):
$$ρ {C}_{p} \frac{\partial T}{\partial t} - ∇ \cdot ( k \cdot ∇ T ) = Q ; \qquad ( 1 )$$
wherein ρ represents density; Cₚ represents specific heat capacity; k represents thermal conductivity; T represents temperature;
$$\frac{\partial T}{\partial t}$$
represents an instantaneous change rate of the temperature T with respect to time t; and Q represents the internal Joule heat source.

7. A detection method based on the system of claim 1, comprising:
step (1) placing the flexible probe on a surface of the blade, wherein the dual-layer meander-type flexible excitation coil, the flexible electromagnetic detection coil array, the thermal insulation aerogel and the patch-type flexible electronic-ionic temperature sensor array are arranged in sequence from bottom to top to form a multi-layer structure, and the thermal insulation aerogel is configured to prevent the patch-type flexible electronic-ionic temperature sensor array from being influenced by internal and external heat sources during an excitation process; and adjusting the flexible probe based on an actual configuration of the blade to fit the surface of the blade;
step (2) before applying the excitation, setting, by the control-storage unit, the amplitude, frequency, phase and excitation time of the excitation current to ensure that the currents with different phases are respectively input into two coil layers of the dual-layer meander-type flexible excitation coil, so as to generate induction eddy currents with different directions;
step (3) during excitation, simultaneously sending, by the control-storage unit, a signal to the temperature acquisition unit, the time-series control unit and the electromagnetic signal acquisition unit to ensure synchronized excitation and acquisition; simultaneously triggering, by the time-series control unit, the current source excitation unit to generate excitations with different phases; picking, by the flexible electromagnetic detection coil array, an electromagnetic signal of substrate crack; and capturing, by the patch-type flexible electronic-ionic temperature sensor array, a temperature signal of both substrate crack and interface debonding;
step (4) at an moment when the excitation is ended, removing the dual-layer meander-type flexible excitation coil, the flexible electromagnetic detection coil array and the thermal insulation aerogel to enable the patch-type flexible electronic-ionic temperature sensor array to fall onto the surface of the blade; and detecting, by the patch-type flexible electronic-ionic temperature sensor array, a temperature signal on the surface of the blade at a cooling stage;
step (5) fusing the temperature signal acquired at the cooling stage with the electromagnetic signal acquired during the excitation process in decision-level; and performing classification and quantification of substrate crack and interface debonding in the thermal barrier coating system based on the decision-level fusion;
wherein in the presence of the substrate crack in the thermal barrier coating system of the blade, a distribution of an eddy current field within the metal substrate will be disturbed, thereby affecting a secondary magnetic field; the flexible electromagnetic detection coil array is configured to pick the change of the secondary magnetic field, so as to identify and quantify the substrate crack based on the electromagnetic signal during the excitation process; and both the substrate crack and the interface debonding will affect thermal conduction process in the thermal barrier coating system, thereby causing a change in temperature distribution on the surface of the blade; and the interface debonding is finally quantified based on disturbed temperature distribution and quantification result of substrate crack from the electromagnetic signal.
